(19) United States
(12) Patent Application Publication
(10) Pub. No.: US 2006/0088805 A1
(43) Pub. Date: Apr. 27, 2006

(54) Reading instruction system and method

(76) Inventor: Narda Pitkethly, Ketchum, ID (US)

Correspondence Address: DYKAS, SHAVER & NIPPER, LLP, P.O. BOX 877, BOISE, ID, 83701-0877, US

(21) Appl. No.: 11/261,435

(22) Filed: Oct. 27, 2005

Related U.S. Application Data
(60) Provisional application No. 60/622,779, filed on Oct. 27, 2004.

(51) Int. Cl. G09B 1/00; G09B 19/00

(52) U.S. Cl. 434/167

(57) ABSTRACT

The invention is a system of reading instruction based on the use of a sound map with pronunciation information about each of the 37 sounds used in spoken English. The sound map can be decoded particularly by an English speaker, and the pronunciation symbols can be used to annotate English text for reading practice and learning.

### PRIORITY

This application is a non-provisional application which claims the priority date from the provisional application entitled READING AID filed by Narda Pitkethly on Oct. 27, 2004 with application Ser. No. 60/622,779, the disclosure of which is incorporated herein by reference.

### BACKGROUND OF THE INVENTION

1. Field of the Invention

The present invention is a device and method for learning to read English and for decoding English language text.

2. Background Information

Some estimates are that as many as 100 million American adults either cannot read or have very poor reading skills. Their lives are seriously affected by reading deficiencies. As children leave the public school system with low reading skills, those numbers will only increase. A recent study found that almost 40% of 4^{th} graders do not read even at a basic level and a majority of students do not read proficiently. This lack of reading proficiency shows up more frequently in low income and disadvantage youth. Approximately 70% of young African-American kids can't read or can't read well. Among Hispanic children, that FIG. is 65%-70%. The majority of these kids who are poor readers or who can't read are children from lower income homes, and improving their success in life will be greatly handicapped without good reading skills.

A challenge that readers of English face is the written English does not present a consistent conversion to spoken English. Although there are 26 letters in the alphabet, there are 37 sounds that are made in spoken English, and one letter can produce as many as four different sounds, and be combined with other letters to produce different sounds. This results in the problem that reading an English word does not tell a person how it is pronounced. For example, the words “no” and “do” both end in the letter “o,” however, both are pronounced differently. This means that generally you have to learn the pronunciation of every word that you are going to use.

One way that people learn to read is to learn how to decode the individual letters and letter combinations in a word, and put the sounds made by each letter or letter pair together to form the series of sounds that form a word. This is a type of decoding and is taught in the form of phonics, as opposed to whole language methods. When a system of decoding is learned, readers can decode the letters of any word form the sound of the word.

With any reading system involving decoding, a pronunciation key or method is needed. This pronunciation key is combined with techniques to learn to decode letters into sounds, and to learn the sounds that letters of the alphabet make to form words in spoken English. It is an object of the invention to provide a system for learning to read, and a pronunciation code to be used in that system.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

There are 37 sounds that are used in spoken English and those 37 sounds are made with 244 letter combinations. The Standard English alphabet of 26 letters starts with A and ends with Z, but certain sounds are not made by any particular letter of the alphabet. Those sounds may require combinations of letters to make the sound, and several letter combinations can make the same sound. Another challenge to reading students is that there is no apparent order to the listing of the letters of the alphabet. This is in contrast to the alphabet for Japanese characters in which characters are grouped according to the sound that they make, with similar sounds grouped together. The organizational principal of the sound map of the invention is that each of the 37 sounds has a symbol, and they are grouped with other symbols in which each member of the group has a similar sound.

The reading instruction system of the invention includes a sound map which lists all of the 37 sounds that are used in spoken English. The sound map is presented in the form of a table, with rows and columns. Each row is information about 1 of the 37 sounds of spoken English. The first column in each row is a listing of sound symbols for a particular sound. Many sounds are made by only one letter of the alphabet. Other sounds can be made by more than one letter, or combinations of letters. In the row for each sound, at least one picture symbol is included which is a word in which that particular sound is made. By recognizing the picture, a person who speaks English will know that the letters C, A, T is pronounced cat, because they would recognize the picture of the cat. By comparing the picture of the cat with the letters which are used to form the word cat, the student can use his knowledge of how to say the word cat and what a cat is, to learn the pronunciation key and the letter symbols for that sound, and thus, use the pronunciation key to decode other words of written English. Along with the sound symbol picture for each sound, a text word for that picture is listed adjacent to the picture. In the example of the picture of the word cat, the word cat would be spelled out adjacent to the picture. Pronunciation code symbols would be adjacent to the letters of the text word to indicate how that sound is pronounced. Thus, the sound map of the invention could be utilized by itself as a key for deciphering words of written English. It could also be utilized with a practice text which is a group of words in English in the form of a story or other reading, with pronunciation symbols added below the text of the reading. These pronunciation symbols would correspond to the pronunciation symbols of the sound map. Thus, the sound map could be used to decode the English text, and the sound map itself could be decoded by the use of the pictures exemplifying each sound, and the reader's knowledge of how to say the object depicted in the picture, such as cat, dog, pig, etc.

The sound map of the invention can also include a column which has illustrations of the position of a reader's lips as he makes each of the sounds in each row of the table. For instance, the picture of the lip position would indicate if the lips were closed, if they formed a small opening, or if they were pulled back wide over the teeth. The sound chart can further include text which describes the sound formation of each of the sounds in each of the rows of the table. For instance, for the letter “A,” the sound formation description could state that the sound is formed with the lips open and the sound comes from the middle of the mouth. A similar description for each of the sounds that are represented by the rows of the table would help a user to learn the pronunciation of each of these sounds. The table can include pronunciation codes or symbols for each of the letters, which would indicate if a particular letter of a word is silent, a soft vowel, a hard vowel, pronounced as a schwa or other variations in pronunciation. For instance, the pronunciation of “th” in teeth is different than the pronunciation of “th” in feather. The sound made by the “th” in teeth is represented by a double underscore under the “th.” The sound made by “th” in feather is represented by a triple underscore under the “th.”

The invention is also a method of teaching English by the use of a decoding process which utilizes several steps. The first step is to provide a sound map as described above, with columns and rows and each of the sounds made in spoken English represented in the sound map. Example words, text of the example words, pronunciation codes or symbols, lip position pictures and sound formation descriptions would all be included in the sound map. The reader would utilize the step of decoding the sound map, and then utilizing the pronunciation learned from the sound map to decode other writings in written English. This could include practice text, which is normal English text with the additional pronunciation codes or symbols corresponding to the sound map, or it could be unmarked readings of English text.

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a portion of the sound map of the invention in which the long vowel sounds are represented.

FIG. 2 is a portion of the sound map of the invention in which the soft vowel sounds are represented.

FIG. 3 is a portion of the sound map which depicts sounds made by the letters P, B, T, and D.

FIG. 4 is a portion of the sound map which depicts sounds made by the letters C, K, G, M, N, L, and R.

FIG. 5 is a portion of the sound map which depicts sounds made by the letters F, V, H, W and Th.

FIG. 6 is a portion of the sound map which depicts sounds made by the letters Z, Sh, Ch, J and Y.

FIG. 7 is a portion of the sound map which depicts sounds made by the letters Oo, U, E, W, Oi, Oy, Ow, and Ou.

FIG. 8 is an example of practice text marked with the pronunciation symbols of the invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

Spoken English language uses only 37 sounds. There are about 250 ways to make the 37 sounds in written English. With the sound map of the invention, a challenged reader need only learn the symbols which can produce 37 different sounds. These sound symbols are letters and combination of letters of the alphabet. The sound map of the invention can be decoded by an English speaker due to the recognizable pictures for each sound. Once the sound map is decided, a learner of written English can use the sound map to decode or sound out each word in English text.

The sound symbols of the sound map are not in the usual alphabetical order. Instead, they are arranged so that similar sounds are grouped together, so the reader can easily see the difference between similar letters.

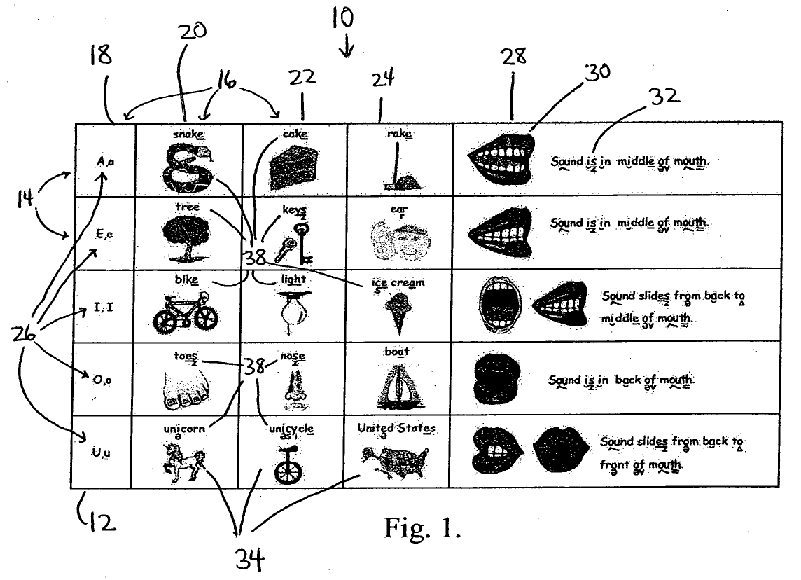

The technology of the invention is illustrated in FIGS. 1-7. FIG. 1 shows the reading instruction system 10 of the invention, with FIG. 1 depicting a portion of the sound map 12 of the invention. The sound map 12 includes a number of rows 14 and columns 16. Each row 14 is related to one of the 37 sounds that are used in the spoken English language. Thus, the entire sound map 12 is made up of 37 rows. Column 1 (18) of the sound map includes the letter or letters which are used in written English to signify a certain sound which is used in spoken English, and those letters are called sound symbols 26. In FIG. 1, the five rows 14 depict five different sounds. The sound of the first row is signified by the letter A, either upper or lower case. All of the five sounds depicted in FIG. 1 are made by the pronunciation of the long vowels A, E, I, O and U. In the system of the invention, vowels always say their name (commonly known as the “long” vowel sound), unless they have a symbol below.

The second, third and fourth columns (20, 22, and 24) contain example words for the pronunciation of each of the sound symbols 26. For the sound symbolized by A, examples of that sound used in specific words includes snake, cake and rake. In each of those example words, an understroke below the letter E indicates that the E is silent. Column 28 includes a depiction of lip position 30 and a sound formation description 32. In FIG. 1, similar sound symbol pictures 34 are included in each row 14 and columns 20 thru 24.

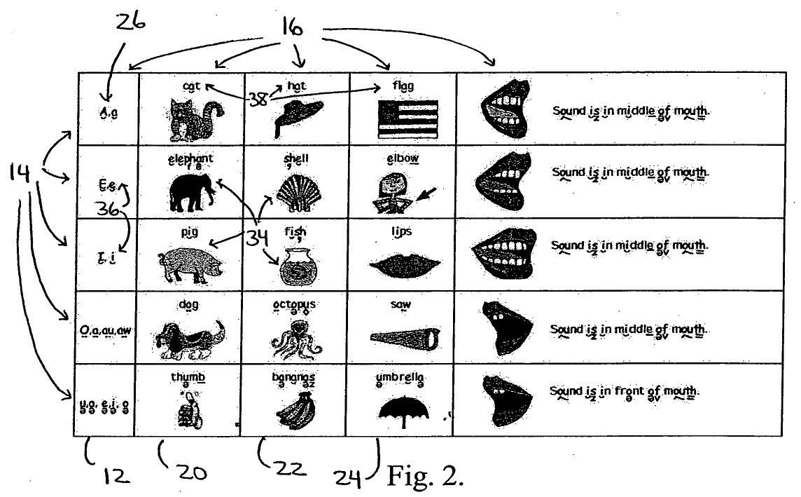

FIG. 2 shows another portion of the sound map 12. In rows 14 and columns 16, an individual sound is depicted in each row, with the sound symbols 26 showing the English text indicators for that sound. The sounds shown in FIG. 2 are the soft pronunciation of the vowels A, E, I, O, U. In addition to the letters A, E, I, O, U, a pronunciation code is included as part of the sound symbols 26. The code for the sound symbols in FIG. 2 is the soft vowel sign.

The fourth row 14 in FIG. 2 depicts four different ways in which the O sound of“dog” can be indicated in text. These include O, A, AU, and AW. When seen in written English, each of these four letters or combination of letters makes the same sound, and that is the sound made by O in the word “dog.” The two dots below the sound symbols for O, A, AU and AW indicate that all of these letters or letter combinations make the short O sound.

In the fifth row of FIG. 2, are listed the sound symbols U, A, E, I and O, with the pronunciation code 36 being an upside down E. In practice text, anytime any of these sound symbols are shown in the text with the upside down E or schwa, the reader knows that the letter is being used to make the schwa sound.

In FIG. 2 as in FIG. 1, columns 20, 22, and 24 include sound symbol pictures 34. They also include sound symbol text 38. The sound symbol text 38 includes pronunciation code 36 to indicate how the sound symbol text 38 is to be pronounced. For example, in the first row of FIG. 2, the word “cat” has a soft vowel indication under the letter A. This indicates that the A in cat is a soft A. Other pronunciation codes are placed throughout the text in FIG. 2 and the other FIGS. to indicate pronunciation.

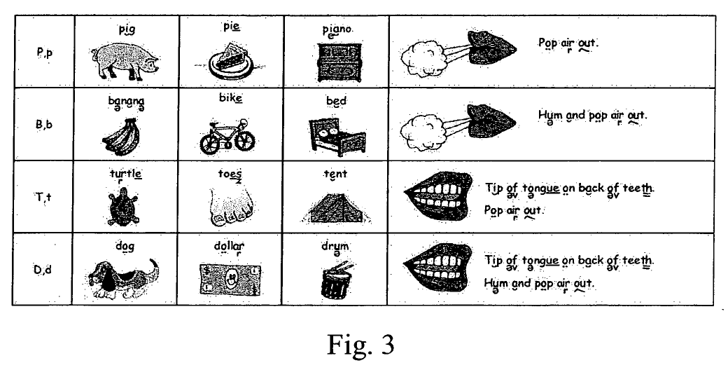

FIG. 3 shows the pronunciation of 4 sounds, the P, D, T, and D sounds. Sometimes these letters and sounds are confused with one another.

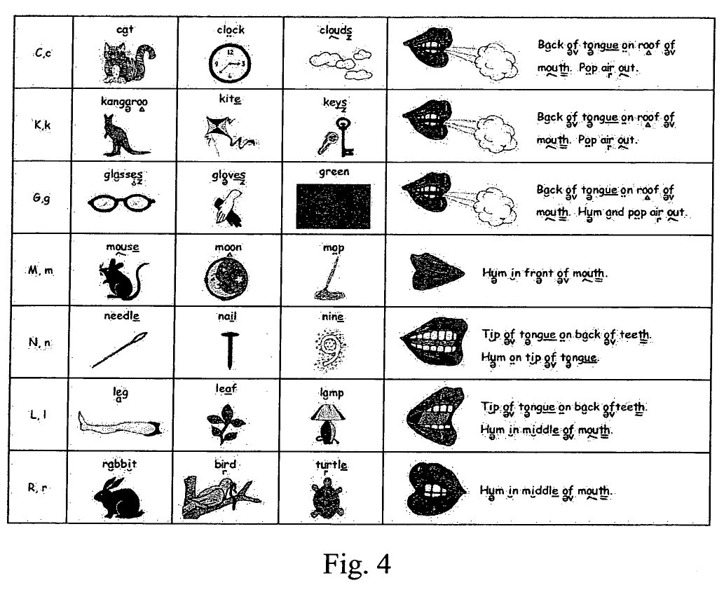

FIG. 4 shows the seven sounds made by the letters C, K, G, L, M, N, and R.

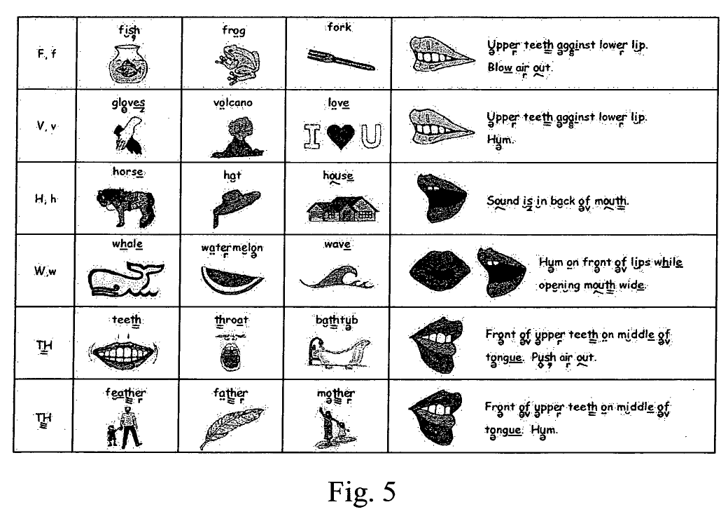

FIG. 5 shows the six sounds made by the letters F, V, H, W, and Th.

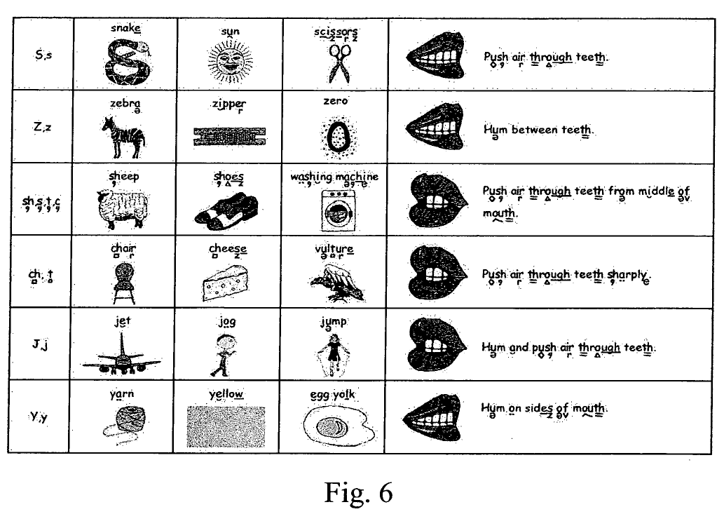

FIG. 6 shows the six sounds made by the letters S, Z, S, T, C, CH, T, J, and Y.

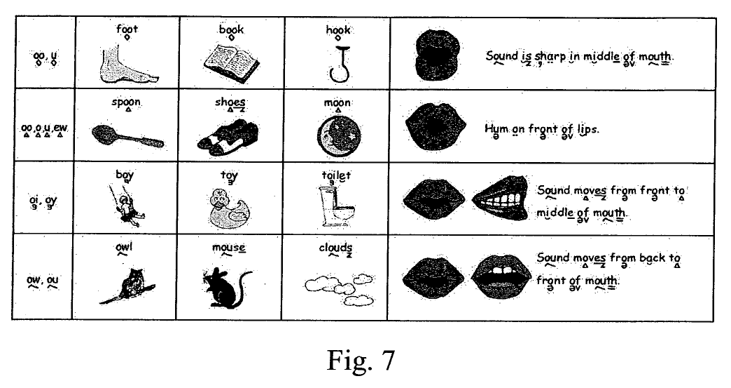

FIG. 7 shows the four sounds that can be made by the letters OO, U, O, EW, OI, OY, OW, OU. Many letters do not make a sound. Whenever a letter is underlined it is silent. For example: Know, thought and you are marked to indicate the silent letters.

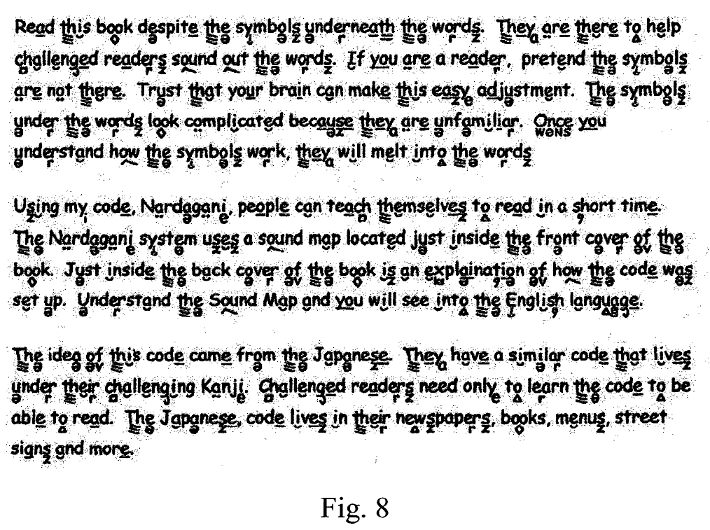

The Sound Map is best used initially with text that has been prepared as practice material in which normally spelled English words are spelled out using the pronunciation codes or symbols shown on the sound map. One aspect of the invention is that the English words do not need to be changed, only symbols added underneath where need be. FIG. 8 is an example of English text that has been marked with the pronunciation symbols of the sound map, and could serve as practice text. This is in contrast to other popular reading systems in which the letters of English words are changed to be phonetic. The strategy of the invention eliminates the problem that English learners experience when transitioning from other systems phonetic alphabet to normal English text

The reading instruction system of the invention could be used on other languages besides English. The sounds of such a language would require certain addition symbols to represent sounds unique to that language. For example in German there are guttural sounds that would need symbols. In Italian or Spanish the rolling R sound will need a symbol.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A reading instruction system for use in reading English text, comprising:
a sound map of possible sounds to pronounce English text, comprising:
a listing of sound symbols, with each sound symbol representing one of the possible sounds in spoken English, and with each sound used in spoken English represented by at least one sound symbol, with selected sound symbols including a pronunciation symbol selected from a group of defined pronunciation symbols; at least one sound symbol picture listed for each sound symbol, with the sound symbol picture representing one or more examples of English words using the sound of the sound symbol, letter, such as pig, banana, dog, cat, for the sounds of P, B, D, and C, for example;
for each sound symbol picture listed, a text word for that picture, such as the words pig, banana, dog and cat for example, with each text word comprised of a correctly spelled word in English, and further comprising pronunciation code symbols adjacent to certain letters of the text word; wherein the pronunciation symbols of the sound map can be added to English text to help a person learn to pronounce written English.

2. The reading instruction system of claim 1 which further comprises:
at least one practice text with conventionally spelled English words and pronunciation code symbols, for a student to use in conjunction with the sound map to practice learning how to decode and read English text, wherein;
a person learning to read English who knows how to speak English can use the sound symbol pictures to identify and learn a sound in an example word, and to use that understanding of how to pronounce a sound made by a letter to decode and read English text in said practice text which has been prepared containing the pronunciation codes of the sound map.

3. The reading instruction system of claim 1 in which each letter or letter combination in written English which is read as a distinct sound in spoken English is depicted as a sound symbol, resulting in one to several letters or letter combinations representing sounds in spoken English as sound symbols.

4. The reading instruction system of claim 1 which further includes a depiction of lip position for each sound symbol, for use by a student in recreating a sound represented by a sound symbol.

5. The reading instruction system of claim 4 which further includes a sound formation description, with instructions on how a sound is formed with the lips.

6. The reading instruction system of claim 1 in which sound symbols for vowel sounds include a pronunciation code for hard or soft pronunciations of said vowel sounds.

7. A reading instruction system for use in reading English text, comprising:
a sound map of possible sounds to pronounce English text, comprising:
a listing of sound symbols, with each sound symbol representing one of the possible sounds in spoken English, and with each sound used in spoken English represented by at least one sound symbol, resulting in one to several sound symbols representing each possible sound in spoken English, with selected sound symbols including a pronunciation code;
at least one sound symbol picture listed for each sound symbol, with the sound symbol picture representing one or more examples of English words using the sound of the sound symbol, letter, such as pig, banana, dog, cat, for the sounds of P, B, D, and C, for example;
for each sound symbol picture listed, a text word for that picture, such as the words pig, banana, dog and cat for example, with each text word comprised of a correctly spelled word in English, and further comprising pronunciation code symbols adjacent certain letters of the text word;
a depiction of lip position corresponding to each sound symbol, for use by a student in recreating a sound represented by a sound symbol;
a sound formation description, with instructions on how a sound is formed with the lips; and
at least one practice text with conventionally spelled English words and added pronunciation code symbols, for a student to use in conjunction with the sound map to practice decoding and reading English text, wherein;
a person learning to read English who knows how to speak English can use the sound symbol pictures to identify and learn a sound in an example word, and to use that understanding of how to pronounce a sound made by a letter to decode and read English text in said practice text which has been prepared containing the pronunciation codes of the sound map.

8. The reading instruction system of claim 1 in which said sound map is arranged in columns and rows, with each distinct sound used in spoken English represented in one row of the sound map, with each column in a particular row containing pronunciation information pertaining to said distinct sound.

9. A method of decoding English text, especially for people who speak English but do not read English, comprising the steps of:
providing a sound map with information about each possible sound of spoken English, said sound map comprising:
a listing of sound symbols, with each sound symbol representing one of the possible sounds in spoken English, and with each sound used in spoken English represented by at least one sound symbol, resulting in one to several sound symbols representing each possible sound in spoken English, with selected sound symbols including a pronunciation code;
at least one sound symbol picture listed for each sound symbol, with the sound symbol picture representing one or more examples of English words using the sound of the sound symbol, letter, such as pig, banana, dog and cat, for the sounds of P, B, D, and C, for example;
for each sound symbol picture listed, a text word for that picture, such as the words pig, banana, dog and cat for example, with each text word comprised of a correctly spelled word in English, and further comprising pronunciation code symbols adjacent certain letters of the text word;
providing at least one practice text with conventionally spelled English words and added pronunciation code symbols, for a student to use in conjunction with said sound map to practice decoding and reading English text;
using said sound map to find the way a particular letter in the practice text is pronounced, by looking up in the sound map a letter or letters from the practice text to discover pronunciation of those letter or letters.

10. The method of decoding English text of claim 7, in which the step of providing a sound map further includes providing a sound map in which each letter or letter combination in written English which is read as a sound in spoken English is depicted as a sound symbol, resulting in one to several letters or letter combinations representing sounds in spoken English as sound symbols.

11. The method of decoding English text of claim 7, in which the step of providing a sound map further includes providing a sound map which further includes a depiction of lip position for each sound symbol, for use by a student in recreating a sound represented by a sound symbol.

12. The method of decoding English text of claim 9, in which the step of providing a sound map further includes providing a sound map which includes a sound formation description, with instructions on how a sound is formed with the lips.
